(19) United States
(12) Patent Application Publication
(10) Pub. No.: US 2013/0159038 A1
(43) Pub. Date: Jun. 20, 2013

(54) System and Method for Interacting With Customers

(71) Applicant: STANLEY CONVERGENT SECURITY SOLUTION, Naperville, IL (US)

(72) Inventors: Ryan J. Fritts, Aurora, IL (US); Beth Anne Tarnoff, Aurora, IL (US); Felix R. Gonzales, Del Mar, CA (US); Lance A. Byerly, Hudson, OH (US)

(73) Assignee: STANLEY CONVERGENT SECURITY SOLUTIONS, INC., Naperville, IL (US)

(21) Appl. No.: 13/710,788

(22) Filed: Dec. 11, 2012

Related U.S. Application Data
(60) Provisional application No. 61/570,484, filed on Dec. 14, 2011.

(51) Int. Cl. G06Q 10/06

(52) U.S. Cl. CPC G06Q 10/06311
USPC 705/7.13

(57) ABSTRACT

A method for interacting with customers is disclosed herein. The method involves creating a service ticket for services to be performed at a customer's site, dispatching a technician to the site, emailing to the customer a notification stating that the technician is on route to the site, transmitting information to the customer. This information may include a service ticket reference number, a service requested by the customer, the name of the technician, a photo of the technician, a listing of the technician's qualifications and/or certifications, a map showing the technician's location and/or the route being followed by the technician, and the technician's estimated time for arrival at the customer's site.

### CROSS-REFERENCE TO RELATED APPLICATION

This application derives priority from U.S. application Ser. No. 61/570,484, filed on Dec. 14, 2011, which is hereby incorporated by reference in its entirety.

### FIELD OF THE INVENTION

The present invention relates to a system and method for interacting with customers.

### BACKGROUND

It is a common occurrence for customers requesting an on-site service, such as a repair or installation, to be provided a general timeframe of several hours for the technician's or installer's arrival with little or no advance warning of the technician's imminent arrival. Furthermore, those customers are not provided information on the technician's or installer's identity, possibly raising security concerns when the technician or installer appears at the premises.

It is an object of the invention to provide a system or method for interacting with customers that provides information for enhancing the customer's service call experience.

### BRIEF DESCRIPTION OF THE DRAWINGS

FIG. 1 depicts a computer system for interacting with customers.

FIG. 2 is a flowchart illustration the method for interacting with customers.

FIG. 3 illustrates an email format for interacting with customers.

### DESCRIPTION

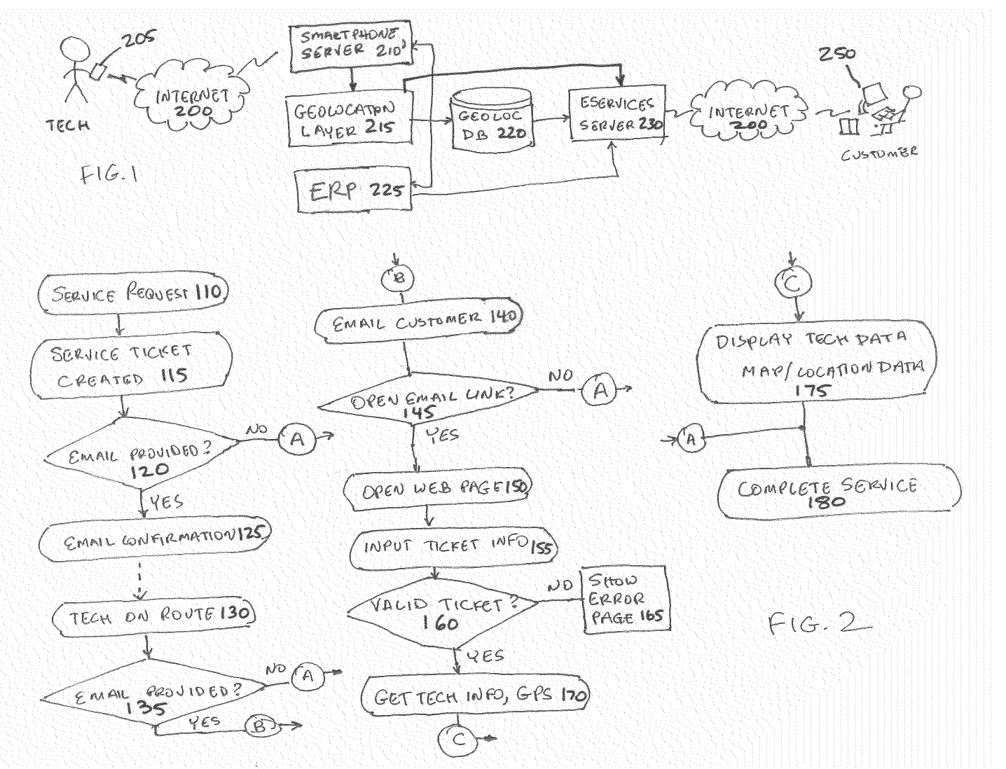

FIG. 2 illustrates a method for interacting with customers. A customer can file a service request (step 110) via the service provider's website, phone or monitoring center A service ticket is then created (step 115, and preferably stored in the service provider's calendar. A technician may be assigned instantly to the service ticket or when the first available technician with appropriate qualifications is available. Such assignment may occur automatically or entered manually by a service coordinator.

If an email address was provided by the customer (step 120), a confirmation email could be sent to the customer (step 125). This confirmation email could provide a link for the customer to check the status of the service call online, in a manner explained below. If no email address was provided by the customer, the technician would just go to the premises at the appropriate location and date and complete the service (step 180).

On the appropriate date of the service call, the technician can confirm his appointment on a calendar and/or confirm that he is en route (step 130). If the customer provided an email address (step 135), an email may be sent out to the customer (step 140), stating the technician is on route to the premises. This email may contain a service call reference number, a summary of the issue requiring the service call and/or a link to the service provider's website to check the status of the service call online. If no email address was provided by the customer, the technician would just go to the premises at the appropriate location and complete the service (step 180).

If the customer decides to open the emailed link (step 145), the customer's browser would open a particular web page (step 150). The customer would then enter the customer's account number and/or service call reference number (step 155).

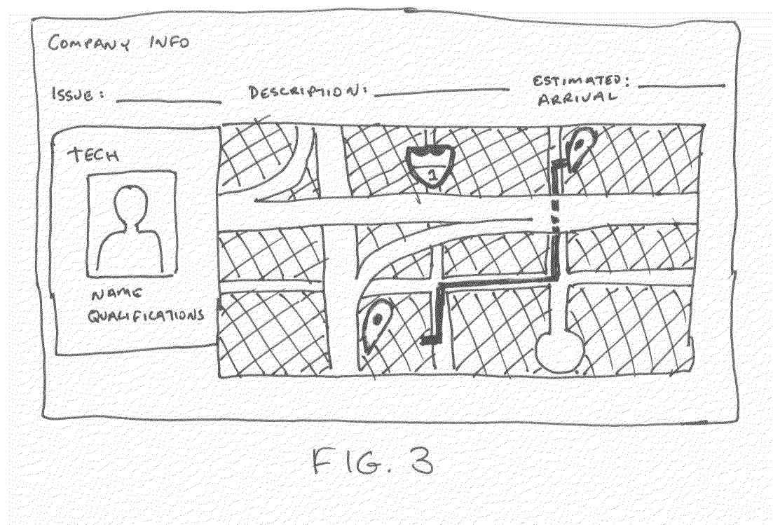

The service provider's website would preferably check whether such information was valid (step 160). If not, an error page is shown (step 165). If the information is valid, information on the technician and his location may be obtained (step 170) and displayed on the webpage (step 175). The information may be displayed in a format such as that shown in FIG. 3, which may include the service call reference number, a description of the issue or requested service, the name and/or photo of the technician, a listing of the technician's certifications and/or qualifications, a map showing the location of the technician (and possibly the location relative to the customer's premises), the route being taken by the technician, and/or the estimated arrival time of the technician.

Once the technician arrives at the premises, the technician can then complete the service call (step 180).

In order to carry out such method of interacting with the customer, it is preferable to provide a system that can be accessed via the internet. Referring to FIG. 1, both the technician and customer can access the internet 200 via a cell phone, smartphone, tablet or computer. Preferably, the technician has a smartphone or tablet 205 with GPS capabilities, so that the technician's location can be sent into the service provider's servers.

Smartphone 205 sends information via the internet 200 to the smartphone server 210, which in turn provides information to enterprise resource planning (ERP) servers 225 and provides GPS location information via the geolocation layer 215. Information from the geolocation layer 215 can be correlated to a geolocation database 220 (or to a mapping website such as Google Maps, Yahoo! Maps, Bing Maps, Mapquest, etc.) All this information can be sent to an e-services server 230 which compiles the information and responds to queries sent by the customer through their smartphone/tablet/computer 250 via internet 200. Preferably the e-services server 230 will respond to the customer's information requests and provide the web page containing the technician's information, location, etc.

The description of the invention is merely exemplary in nature and, thus, variations that do not depart from the gist of the invention are intended to be within the scope of the invention. Such variations are not to be regarded as a departure from the scope of the invention.

What is claimed is:

1. A method for interacting with customers, comprising:
creating a service ticket for services to be performed at a customer's site;
dispatching a technician to the customer's site;
emailing to the customer a notification stating that the technician is on route to the customer's site; and
transmitting information accessible to the customer, said information consisting of at least one of a service ticket reference number, a service requested by the customer, a name of the technician, a photo of the technician, a listing of the technician's qualifications, a listing of the technician's certifications, a map showing the technician's location, a map showing a route being followed by the technician, and the technician's estimated time for arrival at the customer's site.

2. The method of claim 1, wherein the information is transmitted to the customer via at least one of the Internet and a mobile telecommunications network.

3. The method of claim 1, wherein the information is displayable by a computer accessible by the customer.

4. The method of claim 1, wherein the technician's location is provided to a server.

5. The method of claim 4, wherein the information as to the technician's location is provided by a mobile device carried by the technician, the mobile device having GPS location capabilities.
